(19) United States
(12) Patent Application Publication
(10) Pub. No.: US 2015/0274418 A1
(43) Pub. Date: Oct. 1, 2015

(54) METHOD FOR HANDLING MATERIAL IN A MATERIAL CONVEYING SYSTEM, INPUT POINT OF A MATERIAL CONVEYING SYSTEM, AND A MATERIAL CONVEYING SYSTEM

(71) Applicant: MARICAP OY, Vantaa (FI)

(72) Inventor: Göran Sundholm, Tuusula (FI)

(73) Assignee: MARICAP OY, Vantaa (FI)

(21) Appl. No.: 14/437,449

(22) PCT Filed: Oct. 21, 2013
(86) PCT No.: PCT/FI2013/050994

§ 371 Date: Apr. 21, 2015

(30) Foreign Application Priority Data
Oct. 22, 2012 (FI) 20126093

(51) Int. Cl. B65F 5/00; B65F 1/12; B65G 53/40; B65G 53/26; B65F 1/10

(52) U.S. Cl. CPC B65F 5/00; B65G 53/26; B65F 1/105; B65G 53/40; B65F 1/125

(57) ABSTRACT

Method for feeding in and for transporting material in a pneumatic material conveying system, including at least one input point for material, a material conveying pipe connected to an input point, and a material container, in which the material to be conveyed is separated from the transporting air. A partial vacuum/pressure difference and/or a transporting air flow in the conveying pipe is provided at least during the transporting of material. The suction side of the partial-vacuum source is connected to act in the conveying pipe and onwards into an input point arranged in the conveying pipe, or at least into the feed-in channel that is between the conveying pipe and an input point wherein the input point, or at least the feed-in channel, intended for emptying that is closest to the material container in the conveying direction of the material empties and the material displaces into the conveying pipe.

### FIELD OF THE INVENTION

The object of the invention is a method as defined in the preamble of claim 1.

The object of the invention is also an input point, according to claim 8, of a material conveying system.

The object of the invention is also a material conveying system according to claim 18:

### BACKGROUND OF THE INVENTION

The invention relates generally to pneumatic material conveying systems, such as to partial-vacuum transporting systems, more particularly to the collection and conveying of wastes, such as to the conveying of household wastes and litter.

Systems wherein wastes are conveyed in piping by means of suction and/or transporting air are known in the art. In these, wastes are moved long distances in the piping pneumatically, by means of suction and/or a pressure difference, together with the transporting air. The apparatuses are used for, among other things, the conveying of wastes in different institutions, for the conveying of household waste or for the conveying of other waste. It is typical to these systems that a partial-vacuum apparatus is used to achieve a pressure difference, in which apparatus negative pressure is achieved in the conveying pipe with partial-vacuum generators, such as with vacuum pumps or with an ejector apparatus. A conveying pipe typically comprises at least one valve means, by opening and closing which the replacement air coming into the conveying pipe is regulated. One of the convenient solutions of new regional building projects is waste management that will operate with a pipe transport system. This means that sorted wastes are sucked along underground pipes to a waste station that is common to the whole region. The system is clean, odorless and noise-free, and is also a more environmentally friendly solution than conventional waste management and a safer solution from the viewpoint of the nearby environment. On the other hand, there are a lot of quite small sites, such as office properties, commercial properties, industrial properties and especially residential properties or other sites, in which it is desired to achieve a pneumatic pipe transport solution for wastes, but which are not economically viable to equip with their own partial-vacuum generating apparatus or with a separating device and a separate container. Additionally, one problem is that the litter bins in parks and public spaces are emptied too seldom. Another problem is also that objects are put into them, which can be problematic for the personnel manually emptying them, such as sharp objects, e.g. syringes used for drugs or corresponding.

In prior-art solutions the input points for material often have complex valve arrangements, with which the connection of the input point to the conveying piping and/or the access of replacement air from the input point into the conveying piping is controlled. In many cases complex input point arrangements are undesirable. Indeed, needs have arisen wherein the aim is a simpler input point than earlier, having investment costs and operating costs that are advantageous with respect to known solutions and the maintenance of which is easy.

The aim of the present invention is to achieve a novel solution in connection with material conveying systems, by means of which solution the drawbacks of prior art solutions are avoided. Another aim of the invention is to achieve a solution more particularly for rather small systems, in which it is not desired to use complex input points. Yet another aim is to achieve a wastes conveying system, which is suited for use in the collection of the litter of public spaces, such as parks.

### BRIEF DESCRIPTION OF THE INVENTION

The invention is based on a concept wherein the flow resistance of an input point of a pneumatic material conveying system, such as the local resistance produced by an input aperture, or the sum of the flow resistances of a number of input points, is greater than the flow resistance of the material conveying pipe. In this case suction or a transporting air flow is achieved from the input point of the system farther in the direction opposite to the conveying direction of material, even though there are other input points between the input point intended for emptying and the partial-vacuum generator, the input aperture or input apertures of which input points are open and in connection with the material conveying pipe.

The method according to the invention is characterized by what is stated in the characterization part of claim 1.

The method according to the invention is also characterized by what is stated in claims 2-7.

The input point, according to the invention, of a material conveying system is characterized by what is stated in claim 8.

The separating device, according to the invention, for a material conveying system is also characterized by what is stated in claims 9-17.

The material conveying system according to the invention is characterized by what is stated in the characterization part of claim 18.

The material conveying system according to the invention is also characterized by what is stated in claims 19-22.

The solution according to the invention has a number of important advantages. By means of the solutions of the invention the drawbacks of prior art can be avoided. In the solution according to the invention an input point that is surprisingly simple in terms of its means can be applied, the connection of the input aperture of which input point to the conveying pipe is continuously open. The flow resistance of the input point can be acted upon with the size and with the other properties of the input aperture. By arranging a wall extending inwards from the input aperture, from the outer wall, i.e. flange, of an input point, e.g. a collar-shaped wall, the flow resistance of the input point can be magnified. In addition, the infeeding of e.g. unsuitable pieces from the input aperture of an input point into the container space, i.e. into the feed-in channel, can be prevented with the collar-shaped wall of an input aperture. These types of unsuitable pieces are e.g. long pieces, which are not suited for conveying with a pneumatic pipe transport system. The method, input point and system according to the invention do not require complex valve arrangements in connection with the input points. With the solution according to the invention the waste management of public spaces, e.g. parks, can be efficiently managed, in which case when replacing conventional litter bins with input points according to the invention the manual emptying of litter bins is avoided and at the same time the manual handling of possible dangerous objects in connection with emptying is avoided. The access of replacement air from an input point, especially in cases in which material intended for conveying has been fed into the container space of an input point, is improved with a replacement air duct, which extends in an input point from the proximity of the input aperture to the bottom part of the feed-in container, to near the conveying pipe. In this case smooth starting of the movement of material is enhanced. By disposing the replacement air duct in a part of the feed-in channel that, in its cross-sectional direction, is on the material conveying direction side of the material conveying pipe to which it connects, an effective infeed of replacement air into the material conveying pipe, to between adjacent input points, is achieved. This facilitates and enhances material conveying. The solution according to the invention is well suited for use in connection with different types of pneumatic material conveying systems. The material conveying system according to the invention is typically best suited to rather small systems, in which the number of input points is small, e.g. in the region of 1-10 units. The material collection container at the material delivery end of the system can be fixed or it can be a transportation container or a so-called deep collection container-separating device. By using a deep collection container as a separating device, the material conveyed into the collection container can be efficiently stored, and emptying of the container can be performed less frequently. Emptying of the collection container can be performed by lifting the collection container and by transferring the material that has collected in the container from an openable and closable aperture arranged in the bottom part of the container into the container of a transport means, such as of a garbage truck. The transport means can comprise a press for compressing the material so it becomes denser and a hoist for lifting the collection container. With the solution according to the invention, the separating device of a pneumatic pipe transport system for material and the collection container intended for temporary storage of the transported material can be efficiently combined. When the collection container is a so-called deep collection container, which is at least partly embedded below the surface level of the ground, or corresponding surface level, the space requirement can be efficiently reduced. According to one preferred embodiment the deep collection container-separating device comprises a collection container and an external container, into which the collection container is arranged and from which the collection container is lifted for emptying. A mobile partial-vacuum generating apparatus can be used effectively in connection with the material conveying system of the invention to achieve the partial vacuum needed in the pneumatic transportation of material. In this case a dedicated fixed partial-vacuum generating apparatus is not needed in individual material conveying systems. The system thus enables the division of effective operating time of the partial-vacuum source between a number of material conveying systems. The system also enables the offering of the partial-vacuum source of the material conveying system as a service to properties. In addition, the invention enables an effective way to ensure material conveying by using a number of mobile partial-vacuum sources, in which case e.g. in a malfunction situation a primary partial-vacuum source can easily be replaced with a second mobile backup apparatus. The mobile partial-vacuum source according to the invention fits to function in more cramped locations also because it can be arranged in a vehicle, in which space for wastes is not needed at the same time. The solution according to the invention effectively enables a different frequency for the operation of the partial-vacuum source and for the emptying of a container.

### BRIEF DESCRIPTION OF THE FIGURES

In the following, the invention will be described in more detail by the aid of an embodiment with reference to the attached drawings, wherein

FIG. 1 presents a simplified cross-section of an input point according to an embodiment of the invention, when connected to a conveying pipe,

FIG. 1a presents a cross-section along the line Ia-Ia of FIG. 1,

FIG. 2 presents as a cross-section an input point of an embodiment of the invention, when connected to a conveying pipe,

FIG. 2a presents a cross-section along the line IIa-IIa of FIG. 2,

FIG. 3 presents an input point according to an embodiment of the invention,

FIG. 3a presents a cross-section along the line IIIa-IIIc of FIG. 3;

FIG. 3b presents the input point of FIG. 3a in a second operating state, the input hatch being partly open,

FIG. 4 presents in the manner of a series of drawings a partially-sectioned side view of the operation of a system according to an embodiment of the invention, in the input phase,

FIG. 5 presents in the manner of a series of drawings a partially-sectioned side view of the operation of a system according to an embodiment of the invention, in the conveying phase,

FIG. 6 presents a system according to an embodiment of the invention,

FIG. 7 presents a system according to an embodiment of the invention,

FIG. 8 presents a second system according to the invention, and

FIG. 8a presents the emptying phase of the collection tank of the system of FIG. 8.

### DETAILED DESCRIPTION OF THE INVENTION

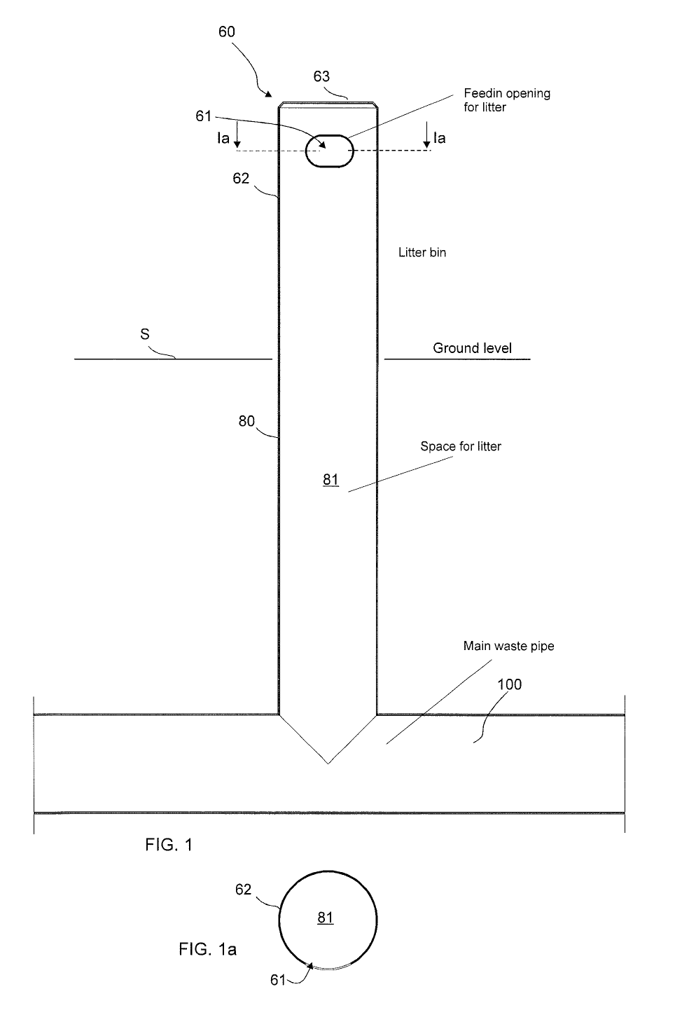

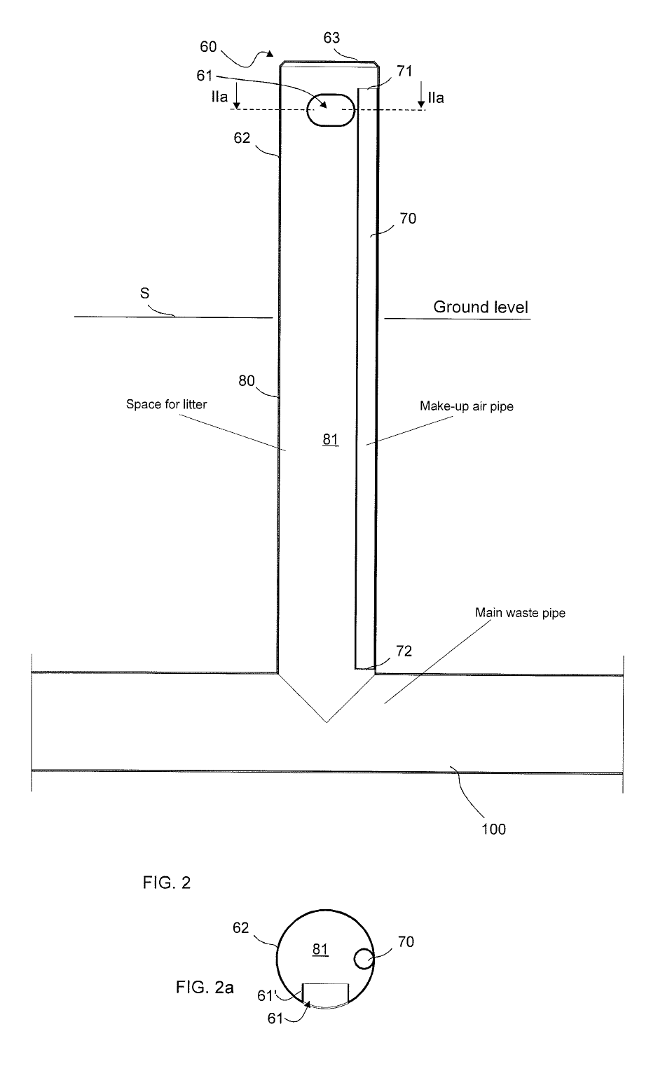

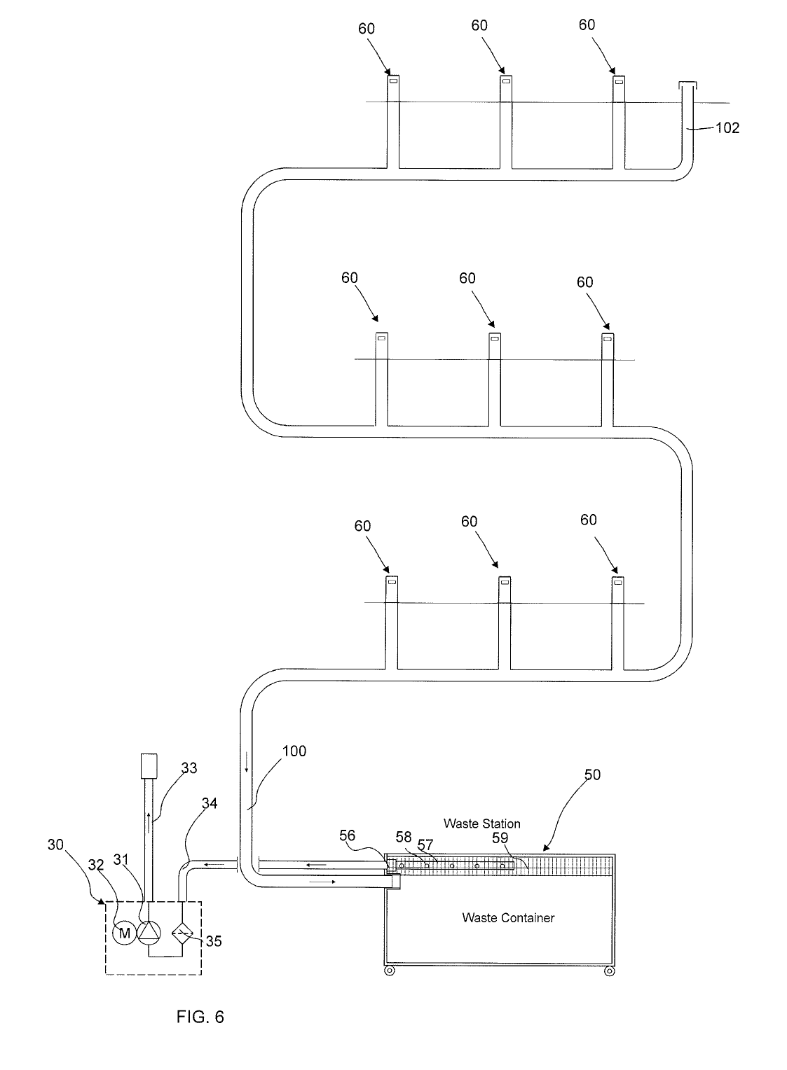

FIGS. 1-2 present a part of a pneumatic material conveying system, which part comprises a material conveying pipe 100, along the side of which at least one, typically many, input points 60 are arranged. An input point 60 is a feed-in station for material, more particularly of waste material, intended to be transported, from which station the material, more particularly waste material, such as litter, household waste, or recyclable material intended to be transported, is fed into the conveying system. An input point 60 can also be a refuse chute, into which material is fed from input apertures on different floors of a building. The system can comprise a number of input points 60, from which the material intended to be transported is fed into conveying piping 100, 100A, 1006, 100C. An input point 60 is connected directly to the conveying pipe 100 or to an inlet pipe 80 in connection with it. Inside the input pipe is a feed-in channel 81, which extends to the conveying pipe 100: The feed-in channel 81 is configured to function as a material space, in which the material fed into the input point is stored, until it is conveyed in the pneumatic material conveying system along conveying piping into a material container, where it is separated from the transporting air. Various material conveying systems are described hereinafter in connection with FIGS. 6-8. In the figure the input point 60 is arranged above a mounting surfaces, such as above the level of the surface of the ground. The feed-in channel 81 extends to a conveying pipe 100 running below the surface of the ground, in which case there is a passage from the input aperture 61 of the input point via the feed-in channel 81 into the conveying pipe 100. An input point comprises a frame, comprising a side wall 62 and a top wall 63. There are one or more input apertures 61, in the embodiment of the figure one, which is arranged in the side wall 62, in the top part of it. In the embodiment of the invention the side wall 62 is an envelope part. The input point according to the invention has been made surprisingly simpler than solutions known in the art before. A valve means is not needed in connection with the input point, but instead the flow resistance of the input point has been configured to be such that the suction or transporting air flow needed for material conveying in the conveying piping is achieved even though the medium connection from the input apertures of the other input points of the system to the conveying pipe are open.

The flow resistance of an input point 60, such as the so-called local resistance caused by an input aperture 61 or the flow resistance produced by a structure acting on the air flow of an input point, is formed or configured to be according to the requirements of the material conveying system. In this case, according to one embodiment, the flow resistance of an input point 60, or the sum of the flow resistances of a number of input points 60, is configured to be greater than the flow resistance of the material conveying pipe. In this case suction or a transporting air flow is achieved in the material conveying pipe also at the point of the farthest input point, even though there is an open medium connection to the conveying pipe 100 from the input aperture 61 of the other input points 60 possibly disposed between the partial-vacuum generator and the input point 60 that is farthest from it against the material conveying direction.

Generally the flow resistances of pipings are usually divided into two groups, friction resistances and local resistances. Friction resistances in a straight pipe depend on, inter alia, the following factors: relative roughness, internal diameter, and the roughness of the internal surface of the wall.

Local resistances are caused by, inter alia, the parts of the piping, in which changes in the flows occur. The changes are caused by, inter alia, pipe curves, contractions and expansions of the pipe, as well as T-pieces, valves and other fittings.

The flow resistance of an input point 60 can be effectively acted upon with, inter alia, the selection of the size of the input aperture 61. In one embodiment of the invention the size of the input aperture 61 is e.g. 150 mm×100 mm, when the aperture is mainly rectangular.

FIGS. 2, 2a present an embodiment of an input point, in which a collar-shaped wall 61′ is arranged in connection with the input aperture 61 of an input point, i.e. a recessed wall 61′ of the input aperture 61 of the input point 60. With the collar-shaped wall 61′ the air flow resistance produced by the input point 60 can be increased. With the same collar-shaped wall, which extends inside the space bounded by the wall 62 of the input point, the infeeding from the input aperture 61 of material pieces that are too long is prevented.

FIGS. 2, 2a present an embodiment of an input point 60, wherein a replacement air duct 70 is arranged in the input point. In the embodiment of the figure, the top end 71 of the replacement air duct 70 is arranged in the top part of the input point, in medium connection with the exterior of the input point, e.g. via the input aperture 61 or via another possible aperture. The replacement air duct 70 extends in the feed-in channel 81 to near the point of connection of the feed-in channel 81 and the conveying pipe 100. In this case the bottom end 72 of the replacement air duct is, in the embodiment of the figure, in the feed-in channel 81 in the proximity of the interface point of the conveying pipe 100, preferably slightly upwards from it.

The replacement air duct 70 is configured to bring replacement air to the point of connection of the conveying pipe 100 and the feed-in channel 80 of the input point, preferably to the edge that is on the side of the main material conveying direction (in which direction the material/transporting air moves when the suction side of the partial-vacuum generator is connected to act in the conveying pipe) of the material conveying pipe. In this case the replacement air can be conducted along the replacement air duct into the conveying pipe, to between the adjacent input point, being emptied earlier in the emptying sequence, and the next to be emptied input point, via the replacement air duct of which input point the replacement air being conducted is in question.

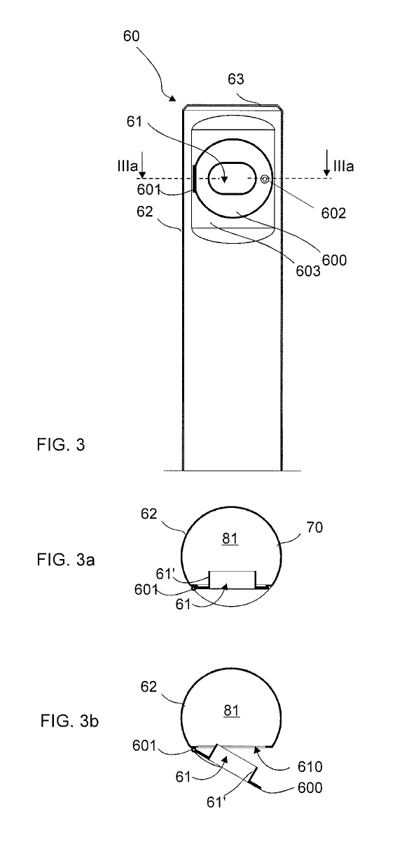

FIGS. 3, 3a and 3b present an embodiment wherein an openable and closable hatch 600 is arranged in the wall 62 of an input point. In the embodiment of the figure an input aperture 61 is arranged in the hatch 600. By opening the hatch 600 (FIG. 3b), material that is such that it is not suited, in terms of its size or other properties, for feeding in via the normally open smaller input aperture 61 can be fed in via the larger input aperture 610. The hatch 600 is arranged in the closed position when the suction of the partial-vacuum source 30 is connected to act in the input point 60. The hatch 600 is arranged in the figures to be openable and closable. In the figure the hatch is arranged with hinge means 601 in a turnable manner onto the frame of the input point. The hatch comprises locking means 602. In the embodiment of FIGS. 3, 3a, 3b, the hatch 600 is arranged in an indented point 603 formed in the side wall of the input point. It can be conceived that the hatch is arranged in some other wall of the input point, e.g. in the top wall 63. In this case the hatch can be such that it does not have a smaller input aperture 61 that is always open.

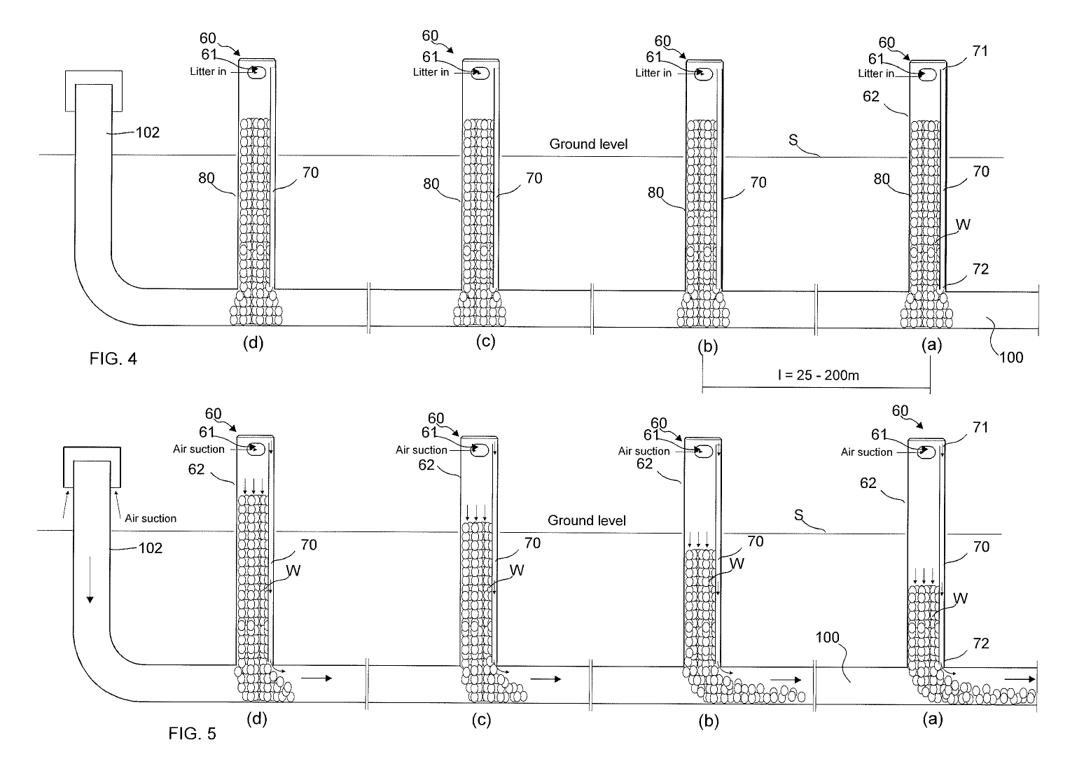

FIGS. 4 and 5 present in a simplified manner of a series of drawings the operation of an embodiment of the invention. FIG. 4 presents a number of input points 60, which are arranged in the feed-in channel section 80 of the conveying pipe 100. Material W, e.g. waste material, litter, et cetera, has been fed into them via the input aperture 61 of the input points. By the aid of gravity the material W has displaced from the input point 61 of an input point in the channel 81 that is inside the feed-in channel part 80 to as far as into the conveying pipe 100, which in the figure is a horizontal pipe, while the feed-in channel part 80 is a vertical pipe section. The distance between input points 60 can vary. According to one embodiment the intermediate distance I can be e.g. 25-200 m.

FIG. 5 presents a situation when the suction side of the partial-vacuum generator of the pneumatic material conveying system is connected to act in the conveying pipe 100. In the figure, the suction is acting from the right-hand side, in which direction the material tries to move. At point (a) the suction has acted in such a way that the material starts moving along with the transporting air in the conveying pipe 100 while replacement air comes both in the conveying pipe and via the input aperture of an input point and via the replacement air duct 70 at first from the input point closest in the material conveying direction in the acting direction of the suction.

In practice the input point that is nearest the material container of the material conveying system empties first. The material W displaces in the conveying pipe towards the delivery end of material, i.e. the material container, and at the same time downwards in the feed-in channel 81 into the conveying pipe 100. When the strength of the suction acts on the material W (at point (b) in FIG. 5) of the second input point, the material of it displaces towards the delivery end and at the same time downwards in the feed-in channel 81 into the conveying pipe. Replacement air has possibly gained access via the replacement air duct 70 of the second input point in question ((b) in FIG. 5) already on the final phase of displacement of the material of the previous input point, which replacement air has boosted the displacement of the material of the previous point along with the transporting air.

In a corresponding manner the suction effect progresses in the conveying piping and empties the input points. The flow resistances of the input points are configured in such a way that at the point (d) in FIG. 5 of also the last input point to be emptied the material W of the input point 60 displaces from the input point into the conveying pipe 100 and onwards in the conveying pipe towards the delivery end, i.e. towards the material container, even though the connection to the conveying pipe 100 of the input apertures 61 of the other input points 60 (at point (a), (b), and (c)) between the input point 60 at point (d) and the material container is open. When all the input points have been emptied and the material has displaced into the delivery end, i.e. into the material container, the suction of the partial-vacuum generator can be switched off. The containers of the input points 60 can again be filled via the input apertures 61 until they are emptied the next time.

FIGS. 6, 7 and 8 present various material conveying systems according to an embodiment of the invention. In the embodiment according to FIG. 6 input points 60 are arranged along the conveying pipe 100. At the end of the conveying pipe is a replacement air duct 102. The conveying pipe is connected to a collection container 50 for material at its other end. A suction pipe 57 having apertures 58 that open into the container space of the material collection container is arranged in the material collection container. A wall 59 allowing air to pass through, such as a net, that prevents waste material getting into the suction apertures of the suction pipe is arranged in the container. The suction pipe is connected with a connection 56 to the suction side channel 34 of the fan 31 of the partial-vacuum generator 30. The partial-vacuum generator is driven with a drive means 32. The blowing side of the partial-vacuum generator is connected to the exhaust pipe 33. In the embodiment of the figure a filtering means 35 is arranged in the duct of the suction side of the partial-vacuum generator.

The conveying piping 100 can be arranged to travel under the surface S of the ground or in cellars. In the embodiment of the figure the conveying piping comprises replacement air ducts 102. In a conveying situation the partial-vacuum generator is connected to function, in which case the suction side of it is connected via the material collection container 50 to the conveying pipe 100. The input points 60 empty starting from the input point that is closest to the material collection container and the material displaces along with the transporting air into the material collection container 50, in which the material separates from the transporting air and remains in the container. The transporting air, for its part, is conducted from the container into the suction pipe 57 and via the suction channel 34 into the exhaust pipe 33. When the input points 60 have been emptied, the partial-vacuum generator 30 can be stopped. The container 50 in the embodiment of the figures is a transportation container, which is configured to be detachable from the conveying pipe 100 and from the suction duct 34. The container 50 can be transported for emptying elsewhere. It can be replaced with an empty container.

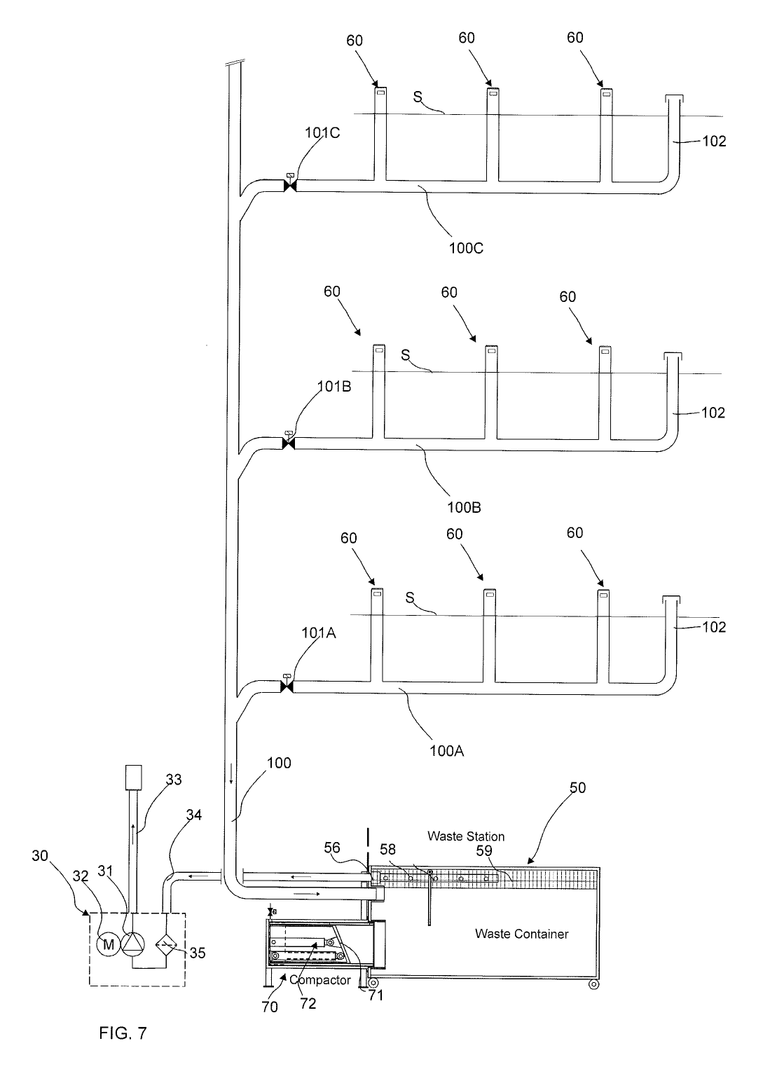

FIG. 7 presents second embodiment of a system according to the invention. In it a number of branch conveying pipes 100A, 100B, 100C are arranged in the main conveying pipe 100, from which branch conveying pipes there is a connection; which is openable and closable with valve means 101A, 101B, 101C, into the main conveying pipe 100. In each branch conveying pipe input points 60 are arranged at a distance from each other. In addition, there is a replacement air duct 102 in each branch conveying pipe. The main conveying pipe 100 is connected to the material collection container 50, in connection with which is arranged a press device/compactor device 70, with the compression means 71 of which the material can be compressed/compacted in the material container 50, said compression means being driven with a drive device 72. The partial-vacuum generator in FIG. 7 corresponds with what is described in connection with FIG. 6. In the embodiment of FIG. 7 the input points 60 are emptied consecutively one branch conveying pipe at a time. In this case the connection from the main conveying pipe 100 into the branch conveying pipe in question is opened with the valve means 101A, 101B, 101C of the branch conveying pipe 100A or 100B or 100C in question that is intended for emptying, in which case the suction effect of the partial-vacuum generator 30 is able to act in the branch conveying pipe. The input points 60 connected to the branch conveying pipe empty, beginning from the input point that is closest to the main conveying pipe and progressing in an emptying sequence that is in the opposite direction with respect to the material conveying direction.

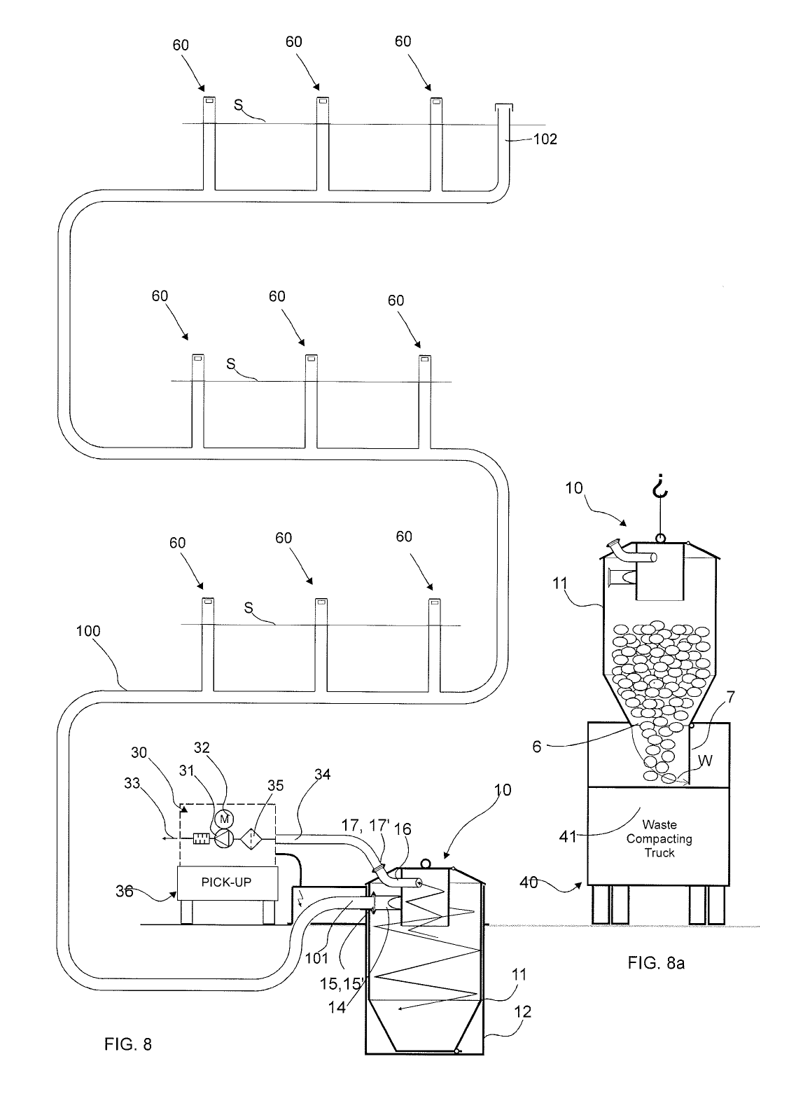

FIG. 8 presents yet another embodiment of the material conveying system according to the invention. In it as a material container is a separating device 10, which is a combination of a deep collection container for material, which is formed from an external container 12 and a collection container 11, and of means arranged in it separating the transporting air and the material being conveyed from each other. According to one embodiment the separating device is a so-called cyclone separator. The conveying pipe 100 can be connected to the collection container 11 of the separating device 10, in which collection container the material W being transported is separated from the transporting air. A connecting means 15′ is formed in the conveying pipe 100 and a counterpart 15 in the branch coupling 14 formed in the top part of the collection container 11. The connecting means 15′ and the counterpart 15 together form e.g. a snap-on coupling. A second connection 17 is formed in the collection container 11, into which connection a pipe or hose 34 coming from the partial vacuum source 30 can be connected with a counterpart 17′. The external container 12 of the deep collection container is embedded to below the surface S of the ground or corresponding.

The partial-vacuum generator is arranged in the embodiment of the figure to be movable. According to the embodiment, the partial-vacuum source 30 is a movable apparatus arranged in a mobile means 36, e.g. in a vehicle. The mobile means 36 can be e.g. a small lorry or a van or the partial-vacuum source 30 can be arranged in a trailer, which can be towed by a vehicle.

In the embodiment of the figure, the material w, such as waste material, separated from the transporting air drifts to the bottom part of the collection container 11. In the figure the drifting of the separated material to the bottom part of the collection container 11 of the separating device 10 is described with an arrow. The material w is presented in the figure as grey. The separated material is removed, e.g. according to need, from the collection container. This material removal phase is presented e.g. in FIG. 8a, in which the collection container is lifted from the external container 12 with lifting means (the lifting device itself is not presented), into the container 41 of a transport means, such as of a garbage truck 40, e.g. via an output aperture 6 for material arranged in the bottom part of the collection container 11, e.g. by opening the hatch 7 closing the output aperture 6.

The invention thus relates to a method for feeding in and for transporting material in a pneumatic waste conveying system, which conveying system comprises at least one input point 60 for waste material, a material conveying pipe 100, which can be connected to an input point 60, and a material container 10, 50, in which the material to be conveyed is separated from the transporting air, and also means for achieving a partial vacuum/pressure difference and/or a transporting air flow in the conveying pipe 100 at least during the transporting of material, which means comprise at least one partial-vacuum source. In the method the suction side of the partial-vacuum source 30 is connected to act in the conveying pipe 100 and onwards into an input point 60 arranged in the conveying pipe or at least into the feed-in channel 81 that is between the conveying pipe and the input point, in which case the input point 60, or at least the feed-in channel 81, intended for emptying that is closest to the material container in the conveying direction of the material empties and the material displaces into the conveying pipe 100, that the flow resistance of an input point 60, such as the flow resistance brought about by the input aperture 61, or the flow resistance brought about by a number of input points 60, such as the flow resistance of the open input apertures 61 of a number of input points 60, is formed to be greater than the flow resistance of the conveying pipe 100 for material in such a way that a transporting air flow is produced in the conveying pipe also in an input point 60 intended for emptying that is farthest in the opposite direction with respect to the conveying direction of the material and/or that the suction produced by the partial-vacuum source acts in the feed-in channel of at least the farthest input point, even though between the suction side of the partial-vacuum source and the input point intended for emptying there is at least one input point having an open input aperture in medium connection with the conveying pipe for material.

According to one embodiment the second, with respect to the input point first emptied, farther input point 60 from the material container 10, 50 in the conveying direction of material, or at least the material w that is in the feed-in channel 81 of is next emptied into the conveying pipe.

According to one embodiment the flow resistance of an input point 60 is acted upon by arranging a collar-shaped wall 61′ in connection with the input aperture 61.

According to one embodiment the infeeding of pieces that are unsuitable in their size via the input aperture 61 of an input point 60 is prevented at least partly with a collar-shaped wall 61′ arranged in connection with the input aperture 61.

According to one embodiment the replacement air is conducted into the conveying pipe 100 via the replacement air duct 70 arranged in connection with an input point, to the point of an input point 60 or feed-in channel 81 of it or into the proximity of them.

According to one embodiment material is fed in before the emptying of an input point 60 from the input aperture 61 of the input point along the feed-in channel 81 to as far as into the conveying pipe 100.

According to one embodiment replacement air is conducted along the replacement air duct 70 into the conveying pipe 100 to between the adjacent input point 60, being emptied earlier in the emptying sequence, and the next to be emptied input point 60, via the replacement air duct 70 of which input point the replacement air being conducted is in question.

The invention also relates to an input point of a pneumatic material conveying system, which input point 60 comprises one or more input apertures 61 for feeding in material into a feed-in channel, which is connected to a conveying pipe 100. The input aperture 61 of an input point 60 is configured to be in medium connection with the conveying pipe 100 for material, and that the flow resistance of an input point 60, such as the flow resistance brought about by the input aperture 61, or the flow resistance brought about by a number of input points 60 that are simultaneously in connection with the conveying pipe, such as the flow resistance of the open input apertures 61 of a number of input points 60, is formed to be greater than the flow resistance of the conveying pipe 100 for material in such a way that a transporting air flow can be produced in the conveying pipe 100 also in an input point 60 intended for emptying that is farthest in the opposite direction with respect to the conveying direction of the material and/or that the suction produced by a partial-vacuum source that can be connected to the conveying pipe can act in the feed-in channel of at least the farthest input point, even though between the suction side of the partial-vacuum source and the input point intended for emptying there is at least one input point having an open input aperture in medium connection with the conveying pipe.

According to one embodiment a collar-shaped wall 61′ is arranged in connection with the input aperture 61 of an input point.

According to one embodiment a replacement air duct 70 to the conveying pipe 100 is arranged in connection with an input point, to the point of the input point 60 or the feed-in channel 81 of it or into the proximity of them.

According to one embodiment a replacement air duct 70 is arranged in connection with an input point 60, which replacement air duct is configured to bring replacement air to the point of connection of the conveying pipe 100 and the feed-in channel 80 of the input point 60, preferably to the edge on the side of the main material conveying direction.

According to one embodiment the top end 71 of the replacement air duct 70 is arranged in the top end of an input point 60, in medium connection with the exterior of the input point, e.g. via the input aperture 61 or via another possible aperture, and that the bottom end 72 of the replacement air duct extends in the feed-in channel 81 into the proximity of the interface point of the conveying pipe 100.

According to one embodiment an openable and closable hatch 600 is arranged in the wall of an input point 60, which hatch is configured to cover an input aperture 610 that is larger than the first input aperture 61.

According to one embodiment an openable and closable hatch 600 is arranged in the wall Of an input point 60, in which hatch an input aperture 61 is arranged.

According to one embodiment between the input aperture 61 of an input point 60 and the conveying pipe 100 there is a medium connection that is always open.

According to one embodiment an input point 60 for material is an input point for waste material or recyclable material.

According to one embodiment an input point 60 for material is configured to function as a rubbish collection point, such as a litter bin.

The invention also relates to a pneumatic material conveying system, which comprises at least one input point 60 for material, which is connected to a conveying piping 100 for material, means for achieving a partial vacuum/pressure difference/transporting air flow in the conveying piping, and also a material container 10, 50, into which the material to be transported together with the transporting air is conducted and in which the transporting air and the material to be transported are separated from each other. The input aperture 61 of an input point 60 of the system is configured to be in medium connection with the conveying pipe 100 for material and that the flow resistance of an input point 60, such as the flow resistance brought about by the input aperture 61, or the flow resistance brought about by a number of input points 60 that are simultaneously in connection with the conveying pipe 100, such as the flow resistance of the open input apertures 61 of a number of input points 60, is formed to be greater than the flow resistance of the conveying pipe 100 for material in such a way that a transporting air flow can be produced in the conveying pipe 100 also in an input point 60 intended for emptying that is farthest in the opposite direction with respect to the conveying direction of the material and/or that the suction produced by a partial-vacuum source that can be connected to the conveying pipe can act in the feed-in channel of at least the farthest input point, even, though between the suction side of the partial-vacuum source and the input point intended for emptying there is at least one input point having an open input aperture in medium connection with the conveying pipe.

According to one embodiment the system comprises a number of input points 60 arranged along the conveying piping 100, for emptying which input points the suction side of a partial-vacuum generator 30 is connected to the material container 50, 10 and from where there is a flow connection onwards into the conveying pipe 100.

According to one embodiment the system comprises a material container 50, which is a transportation container.

According to one embodiment the system further comprises a material container 50, 10, which is a deep collection container-separating device 10, into which material is conveyed from input points 60 via a conveying pipe 100, by means of suction/a pressure difference produced by a partial-vacuum source 21, and that in the emptying phase the collection container 11 is lifted with lifting means and the material w that has collected in the collection container 11 is emptied via an openable and closable aperture 6 arranged in the bottom part of the collection container 11.

According to one embodiment an input point 60 according to the characteristic features of any of the aforementioned embodiments is configured for use in the system.

The mobile partial-vacuum source presented e.g. in publication WO2011151522, or an ordinary partial-vacuum source arranged in the proximity of the separating device, e.g. in a container, can be used in the system and method according to the invention.

It is obvious to the person skilled in the art that the invention is not limited to the embodiments presented above, but that it can be varied within the scope of the claims presented below. The characteristic features possibly presented in the description in conjunction with other characteristic features can if necessary be used separately to each other.

1. Method for feeding in and for transporting material in a pneumatic material conveying system, which conveying system comprises at least one input point for material, a material conveying pipe, which can be connected to an input point, and a material container, in which the material to be conveyed is separated from the transporting air, and also means for achieving a partial vacuum/pressure difference and/or a transporting air flow in the conveying pipe at least during the transporting of material, which means comprise at least one partial-vacuum source, comprising the following steps:
connecting the suction side of the partial-vacuum source to act in the conveying pipe and onwards into an input point arranged in the conveying pipe, or at least into the feed-in channel that is between the conveying pipe and an input point, in which case the input point, or at least the feed-in channel, intended for emptying that is closest to the material container in the conveying direction of the material empties and the material displaces into the conveying pipe,
creating a flow resistance of an input point, such as the flow resistance brought about by an input aperture, or the flow resistance brought about by a number of input points, such as the flow resistance of the open input apertures of a number of input points, is formed to be greater than the flow resistance of the conveying pipe (100) for material,
producing a transporting air flow in the conveying piping also in the input point intended for emptying that is farthest in the opposite direction with respect to the conveying direction of the material and/or that the suction produced by the partial-vacuum source acts in the feed-in channel of at least the farthest input point, even though between the suction side of the partial-vacuum source and the input point intended for emptying there is at least one input point having an open input aperture in medium connection with the conveying pipe for material.

2. Method according to claim 1 wherein the second, with respect to the input point first emptied, farther input point from the material container in the conveying direction of material, or at least the material that is in the feed-in channel of it, is next emptied into the conveying pipe.

3. Method according to claim 1, wherein the flow resistance of an input point is acted upon by arranging a collar-shaped wall in connection with the input aperture.

4. Method according to claim 1, wherein the infeeding of pieces that are unsuitable in their size via the input aperture of an input point is prevented at least partly with a collar-shaped wall arranged in connection with the input aperture.

5. Method according to claim 1, wherein the replacement air is conducted into the conveying pipe via the replacement air duct arranged in connection with an input point, to the point of an input point or the feed-in channel of it or into the proximity of them.

6. Method according to claim 1, wherein material is fed in before the emptying of an input point from the input aperture of the input point along the feed-in channel to as far as into the conveying pipe.

7. Method according to claim 1, wherein replacement air is conducted along the replacement air duct into the conveying pipe to between the adjacent input point, being emptied earlier in the emptying sequence, and the next to be emptied input point, via the replacement air duct of which input point the replacement air being conducted is in question.

8. Input point of a pneumatic material conveying system, which input point comprises one or more input apertures for feeding in material into a feed-in channel, which is connected to a conveying pipe, wherein the input aperture of an input point is configured to be in medium connection with the conveying pipe for material, and in that the flow resistance of an input point, such as the flow resistance brought about by the input aperture, or the flow resistance brought about by a number of input points that are simultaneously in connection with the conveying pipe, such as the flow resistance of the open input apertures of a number of input points, is formed to be greater than the flow resistance of the conveying pipe for material in such a way that a transporting air flow can be produced in the conveying pipe also in an input point intended for emptying that is farthest in the opposite direction with respect to the conveying direction of the material and/or that the suction produced by a partial-vacuum source that can be connected to the conveying pipe can act in the feed-in channel of at least the farthest input point, even though between the suction side of the partial-vacuum source and the input point intended for emptying there is at least one input point having an open input aperture in medium connection with the conveying pipe.

9. Input point according to claim 8, wherein a collar-shaped wall is arranged in connection with the input aperture of an input point.

10. Input point according to claim 8, wherein a replacement air duct to the conveying pipe is arranged in connection with an input point, to the point of an input point or the feed-in channel of it or into the proximity of them.

11. Input point according to claim 8, wherein a replacement air duct is arranged in connection with an input point, which replacement air duct is configured to bring replacement air to the point of connection of the conveying pipe and the feed-in channel of the input point; preferably to the edge on the side of the main material conveying direction.

12. Input point according to claim 8, wherein the top end of the replacement air duct is arranged in the top part of an input point, in medium connection with the exterior of the input point, e.g. via the input aperture or via another possible aperture, and in that the bottom end of the replacement air duct extends in the feed-in channel into the proximity of the interface point of the conveying pipe.

13. Input point according to claim 8, wherein an openable and closable hatch is arranged in the wall of an input point, which hatch is configured to cover an input aperture that is larger than the first input aperture.

14. Input point according to claim 8, wherein an openable and closable hatch is arranged in the wall of ah input point, in which hatch an input aperture is arranged.

15. Input point according to claim 8, wherein between the input aperture of an input point and the conveying pipe there is a medium connection that is always open.

16. Input point according to claim 8, wherein an input point for material is an input point for waste material or recyclable material.

17. Input point according to claim 8, wherein an input point for material is configured to function as a rubbish collection point, such as a litter bin.

18. Pneumatic material conveying system, which comprises at least one input point for material, which is connected to the conveying piping for material, means for achieving a partial vacuum/pressure difference/transporting airflow in the conveying piping, and also a material container, into which the material to be transported together with the transporting air is conducted and in which the transporting air and the material to be transported are separated from each other, wherein the input aperture of an input point of the system is configured to be in medium connection with the conveying pipe for material, and in that the flow resistance of an input point, such as the flow resistance brought about by the input aperture, or the flow resistance brought about by a number of input points that are simultaneously in connection with the conveying pipe, such as the flow resistance of the open input apertures of a number of input points, is formed to be greater than the flow resistance of the conveying pipe for material in such a way that a transporting air flow can be produced in the conveying pipe also in an input point intended for emptying that is farthest in the opposite direction with respect to the conveying direction of the material and/or that the suction produced by a partial-vacuum source that can be connected to the conveying pipe can act in the feed-in channel of at least the farthest input point, even though between the suction side of the partial-vacuum source and the input point intended for emptying there is at least one input point having an open input aperture in medium connection with the conveying pipe.

19. System according to claim 18, wherein the system comprises a number of input points arranged along the conveying piping for emptying which input points the suction side of a partial-vacuum generator is connected to the material container and from where there is a flow connection onwards into the conveying pipe.

20. System according to claim 18, wherein the system comprises a material container, which is a transportation container.

21. System according to claim 18, wherein the system further comprises a material container, which is a deep collection container-separating device, into which material is conveyed from input points via a conveying pipe, by means of suction/a pressure difference produced by a partial-vacuum source, and in that in the emptying phase the collection tank is lifted with lifting means and the material that has collected in the collection tank is emptied via an openable and closable aperture arranged in the bottom part of the collection tank.

22. (canceled)
